(19) United States
(12) Patent Application Publication
(10) Pub. No.: US 2006/0116442 A1
(43) Pub. Date: Jun. 1, 2006

(54) Aqueous thermochromic and photochromic motor vehicle paints and methods of use

(76) Inventors: Clinton E. Gallo, Magnolia, TX (US); Christopher Gallo, Harahan, LA (US)

Correspondence Address: Clinton Gallo, 519 Westwood North Drive, Magnolia, TX, 77354, US

(21) Appl. No.: 10/999,057

(22) Filed: Nov. 29, 2004

(51) Int. Cl. C08K 3/02; C08K 9/00

(52) U.S. Cl. 523/200; 524/80

(57) ABSTRACT

The invention consists of the composition of reversible thermochromic and photochromic leuco dyes wherein the thermochromic and photochromic material is in the form of microencapsulated powder, or aqueous slurry and combined with non-solvent, aqueous based automotive paint for use in painting, coating, or covering the exterior surfaces of motor vehicles, more specifically automobiles, trucks, motorcycles, boats, airplanes, snowmobiles, bicycles, and any other propelled land, sea, or air vehicle, the process of applying these paints/coatings, and the methods of their use. The term “reversible leuco dye” refers to leuco dyes which have the property of going from a color state to a clear state when a stimulus is applied, and returning to the colored state when the stimulus is removed. The stimulus in this case would be exposure to heat for the thermochromic leuco dyes, or light for the photochromic ones. When applied to the exterior of a motor vehicle the reversible thermochromic leuco dye paint will cause the exterior of the motor vehicle to change colors with changes in the temperature thereof. When applied to the exterior of a motor vehicle the reversible photochromic paint described above will cause the exterior of a motor vehicle to change colors with exposure to light.

### CROSS REFERENCE TO RELATED APPLICATONS

Provisional patent application number 60/525,660. Filing date Dec. 01, 2003.

### BACKGROUND OF THE INVENTION

The invention pertains to the field of thermochromic and photochromic dye formulations. More particularly the invention pertains to thermochromic and photochromic formulations for aqueous automotive paints used in motor vehicle painting, the method of creating these formulations, and the process of applying these formulations to motor vehicles such that the color changing properties of the paint is preserved.

Thermochromic and photochromic encapsulated dyes, commonly called leuco-dyes were invented many years ago and are commercially available from several manufacturers. The thermochromic and photochromic pigments are encapsulated in a melamine formaldehyde capsule. The thermochromic pigment changes from a colored state to a clear state over a short temperature range of about 5 degrees F. The temperature at which the pigment changes can be engineered by the manufacturer in the range of −15 C to 65 C (5 F-149 F). The pigments are available in many colors including, but not limited to Red, rose red, magenta, vermillion, orange, yellow, green, yellow green, sky blue, dark blue, violet, and black. The photochromic pigment changes from a colored state to a clear state upon exposure to sunlight. The pigments are available in many colors including, but not limited to Red, rose red, magenta, vermillion, orange, yellow, green, yellow green, sky blue, dark blue, violet, and black.

Melamine formaldehyde makes up the microcapsule's outer casing. It is a thermo-set resin and it will not break down at high temperature. The capsules are insoluble in most solvents, however they are permeable and can allow solvents and other external agents enter the capsule and destroy the color changing properties of the thermochromic and photochromic pigments. The ability of these solvents and other agents to permeate and destroy the color changing properties of the thermochromic and photochromic pigments is very important to the commercial success of products made with these pigments.

Heretofore inventors have attempted to incorporate the thermochromic and photochromic pigments into solvent based inks, lacquers, and plastics. As previously disclosed solvents can permeate and destroy the thermochromic and photochromic pigments and limit the length of time that the color changing effects will last. This limits the commercial viability of any product using the thermochromic and photochromic pigments. Due to the short shelf life of these types of formulations they are not suitable for use as motor vehicle exterior paint.

Recently, aqueous automotive paints have been developed which we have found to be highly compatible with the thermochromic and photochromic leuco dyes. These aqueous automotive paints are commercially available from a number of retailers. They are non-toxic, non-solvent based automotive paints which have, or can be engineered to have a neutral ph value. By combining this paint with the thermochromic and photochromic leuco dyes we have been able to preserve the color changing properties of the paint that heretofore have been destroyed by the solvents in traditional automotive paint systems. This discovery combined with the method of applying a non solvent based paint barrier between the primer coat and thermochromic and photochromic paints of this invention, and a aqueous clear top coat barrier, and doping the top aqueous clear coat with 15%-30% benzophenone sun block has preserved the color changing properties beyond 1 year, and thus we have discovered a commercially viable color changing automotive paint system.

In the prior art of thermochromic ink formulations and methods of use Small, et. al., U.S. Pat. No. 6,139,779 discloses solvent-based ink formulations for printing use, and a color changing nail polish. The patent does not claim aqueous automotive paint containing thermochromic or photochromic materials, or the process of applying them to a motor vehicle.

In the prior art of effect painting for toys Hippely, et. Al, U.S. Pat. No. 4,917,643 discloses a toy vehicle coated with spray paint containing thermochromic material. The patent pertains to paint used for toy vehicles only. This patent does not claim a aqueous automotive paint containing thermochromic or photochromic materials for use on real motor vehicles.

In the prior art of effect painting for motor vehicle bodies Sailer, U.S. Pat. No. 5,733,976 discloses an effect paint comprising liquid crystal polymer compounds. The patent pertains to paints that appear to have a different color when viewed at different angles. The patent does not claim color changing properties using photochromic or thermochromic materials.

In the prior art of active vehicle coating Bettinger, U.S. Pat. No. 6,475,559 discloses a conformable coating, comprising a heat-shrink polymeric matrix sheet embedded with and enveloping active and constant tonal and coloring material and coated with an adhesive layer. This patent discloses a the use of a “heat shrink polymeric substantially non-opaque matrix sheet fabricated from substantially transparent compositions of polyurethane, polyester, and polyolefin resins” and does not claim aqueous automotive paint containing thermochromic or photochromic materials. There are problems with using a heat-shrink polymeric matrix sheet for many applications of thermochromic and photochromic coatings for motor vehicles. One problem is that it limits artistic creativity needed to produce one of a kind custom paint jobs for motor vehicles, such as motorcycles, and custom automobiles. Another problem is that it's application requires special equipment and training whereas the paint of the present invention can be applied by any conventional motor vehicle painting method requiring no special training or equipment.

In the prior art of thermochromic effect coating AKOZ N.V., European Patent No. EP 0 357 844 B1 discloses an aqueous coating composition containing combinations of aqueous binders, flop effect pigments, and encapsulated thermochromic liquid crystal pigments. The patent pertains to compositions containing flop effect pigments which have different colors at different viewing angles, and encapsulated thermochromic liquid crystals. Our formulation does not utilize flop effect pigments, or liquid crystal pigments.

### BRIEF SUMMARY OF THE INVENTION

To overcome the deficiencies of the prior art this invention teaches an effect paint comprising a homogeneous mixture of aqueous motor vehicle paint and reversible thermochromic and or photochromic material for use on motor vehicles exteriors to produce a distinct color changing effect for decorative and functional purposes.

A method of applying the effect paint to extend the life of the color changing properties of the thermochromic and photochromic dyes within the paint such that it is commercially viable.

A method of heating and cooling the painted surfaces of motor vehicles to produce a color change effect on demand.

### DETAILED DESCRIPTION OF THE INVENTION

In traditional automotive paint systems solvent-based paints are used. These solvent-based systems are not compatible with thermochromic or photochromic leuco dyes, and causes them to decompose at a very rapid rate. The invention utilizes a non-solvent aqueous based, environmentally safe paint system in combination with the thermochromic and photochromic leuco dyes. The invention includes the process of using water based, non-toxic, acrylic enamel, which meets ASTMD-4236 standards. This non-solvent based, environmentally safe paint system, in combination with the thermochromic or photochromic leuco dyes, creates a composition which is suitable for automotive use and which does not degrade the color changing properties of the leuco dyes, and has the same enduring finish as a normal non color changing paint.

The process is to apply a ph balanced water based paint coating as the base coat to protect the thermochromic or photochromic leuco dye paint composition from harmful external agents that might diminish the color changing properties of the composition. Next the thermochromic or photochromic automotive paint composition is applied onto the exterior surface of the motor vehicle and allowed it to dry. Once the paint is dried a clear top coat consisting of another ph balanced water based, clear paint top coat is applied to protect the thermochromic or photochromic leuco dye paint composition from harmful external agents that might diminish the color changing properties of the composition. This process encases the thermochromic and photochromic leuco dye compositions in a protective shell to prolong the color changing properties of the composition. Through this process we have been able to extend the color changing properties of the composition for over 2 years. As a final protection measure a urethane clear coat mixed with a sun blocking agent and enamel hardener is applied and cured in a traditional automotive paint drying booth.

The thermochromic leuco dye composition can be made to change form one color to another at a certain temperature, from a color to a clear state, or to different colors at different temperature ranges. The photochromic leuco dye composition will change from one color to another, or from a color to a clear state with exposure to light. The thermochromic and photochromic leuco dye compositions can be made into a clear base, which will change to a color at a specified temperature. This allows for underlying features, like designs, emblems, and names to be hidden and only appear when exposed to a specified temperature when the reversible, thermochromic leuco dye returns to a clear state. Like wise the same principle can be applied to the photochromic leuco dye to hide and expose underlying features by exposure to light.

The main object of the invention is to provide a means by which the painted surfaces of a motor vehicle can be changed from one color to another for decorative and functional purposes.

Another object of this invention is the method of producing a color change effect using forced, heated and/or cooled air, pressurized gas, and/or electronic devices to produce a color change on demand by heating and/or cooling the painted surfaces of the motor vehicle to produce the change. By heating and cooling the surfaces painted with the thermochromic automotive paint composition, one can control the color of the vehicle. One method of doing this is to force the air generated by the heater and air conditioner of an automobile, or other vehicle into the body panels of the vehicle to heat and cool them. Another method would be force heated air from a motorcycle or other vehicle's engine onto the vehicle's painted surfaces using a fan or blower. Likewise, there are various methods of cooling the vehicle's exterior by releasing pressurized gas such as nitrogen, CO2, air, etc.

Yet another object of this invention the process of imbedding thin electrical wires into the aqueous thermochromic paint during the painting process to enable electrically controlled heating of the surrounding thermochromic paint described above applied to the vehicle substrate. These wires can be formed into many different patterns to facilitate a image appearing before a complete color change of the painted surface.

Another object of the invention is to provide a means by which the exterior painted surfaces of a motor vehicle can be changed from one color to another on demand by controlling the temperature of the surface of the vehicle for decorative and functional purposes.

Another object of the invention is to provide a means by which the exterior painted surfaces of a motor vehicle can be changed from one color to another by exposure to light for functional and decorative purposes.

Another object of the invention is to provide a means by which the exterior painted surfaces of a motor vehicle can be changed from one color to a clear coating for the purpose of concealment and exposure of underlying art.

Another object of the invention is to disclose methods of combining thermochromic leuco dyes and aqueous motor vehicle paints which preserves the color changing properties of the paint composition.

Another object of the invention is to disclose methods of combining photochromic leuco dyes and aqueous motor vehicle paints which preserves the color changing properties of the paint composition.

Still another object of the invention is to disclose a process of painting motor vehicles with the effect paint, which protects the paint from harmful agents such as solvents and ultraviolet light radiation.

Yet another object of the invention is to disclose methods of heating and cooling the exterior of a motor vehicle using electromechanical devices to produce a color change on demand.

Another object of the invention is to disclose a method of causing a color change of a motor vehicle via remote control devices.

Still another object of the invention is to provide a method of economically coating a motor vehicle with a color changing paint composition employing traditional motor vehicle painting methods such as spray painting, dipping, or brushing on the paint.

The preferred embodiment of the invention is a motor vehicle paint containing color changing material from the classes of thermochromic liquid crystals and leuco dyes.

Another preferred embodiment of the invention is a motor vehicle paint containing color changing material from the classes of photochromic liquid crystals and leuco dyes.

Another preferred embodiment of the invention is a motor vehicle painted with thermochromic color changing motor vehicle paint, which changes colors in response to changes in temperature.

Another preferred embodiment of the invention is a motor vehicle painted with photochromic color changing motor vehicle paint, which changes colors in response to exposure to light.

Another preferred embodiment of the invention is a motor vehicle painted with thermochromic color changing paint, which changes color on demand by use of electromechanical heaters and coolers affixed to the substrate motor vehicle.

Another preferred embodiment of the invention is a motor vehicle painted with thermochromic color changing paint, which changes color on demand by remote control.

Another preferred embodiment of the invention is a motor vehicle mechanical part painted with thermochromic color changing paint, which changes color when the normal operating temperature is exceeded to provide a visual indication of a possible mechanical problem. Thus a race car's crew can visually inspect components at a pit stop to correct problems before a failure.

Another preferred embodiment of the invention is a motor vehicle painted with thermochromic color changing paint graphics or art, which is the same color as the underlying substrate motor vehicle part when cold and upon heating the graphics or art become visible.

1- We claim an aqueous based color changing automotive paint composition of reversible thermochromic and/or photochromic leuco dyes wherein the thermochromic and photochromic material is in the form of microencapsulated powder, or aqueous slurry and combined with non-solvent, aqueous based automotive paint for use in painting or covering the exterior surfaces of motor vehicles, more specificaly automobiles, trucks, motorcycles, boats, airplanes, snowmobiles, bicycles, and any other propelled land, sea, or air vehicle.

2- We claim a method of formulating a aqueous based color changing automotive paint of claim one comprising:
a—a thremochromic pigment wherein said pigment is formed of microcapsules each containing reversible thermochromic leuco dye coloring material which exhibits a visible color change between a color and a clear state in response to a change in temperature.
b—a photochromic pigment wherein said pigment is formed of microcapsules each containing reversible photochromic leuco dye coloring material which exhibits a visible color change between a color and a clear state in response to a change in light exposure.
c—a aqueous based, ph balanced automotive paint that contains no solvents that are harmful to the color changing effects of the thermochromic or photochromic material of claim 1. The paint described here can be of any color, or colorless.

3- We claim a process of applying a aqueous based color changing paint of claim 1 to the exterior of a motor vehicle described in claim 1 to preserve the color changing properties of said paint comprising:
a—Applying a aqueous based automotive paint of claim 2-b to the surface of a motor vehicle as a base and protective coating to the color changing materials of claim 2-a.
b—Applying the color changing paint composition of claim 1 over the protective base coat of claim 3-a to a thickness of at least 4 mils.
c—Applying another protective aqueous based clear automotive paint of claim 2-c over the color changing paint composition of claim 1 and 3-b, which incorporates UV radiation blocking agents such as benzophenome to form an protective barrier against external agents, such as solvents and UV which could harm the color changing properties of said paint.
d—Applying an automotive clear coat paint containing UV radiation blocking (Sun block) to protect the underlying paint's color changing properties from harm caused by over exposure to sunlight, and to provide the durability of a normal automotive paint finish.

4- We claim a method of heating and cooling the exterior painted surfaces of a motor vehicle described in claim 1 to induce the color change effect of said vehicle on demand using electromechanical devices comprising:
a—The process of imbedding thin electrical wires into the aqueous thermochromic paint during the painting process to enable electrically controlled heating of the surrounding thermochromic paint described above applied to the vehicle substrate. These wires can be formed into many different patterns to facilitate a image appearing before a complete color change of the painted surface.
b—The process of affixing a electronic heating device behind or beneath a motor vehicle substrate part to induce the color changing effect by heating said part.
c—The method of producing a color change effect using forced, heated and /or cooled air, or pressurized gas to produce a color change on demand by heating and/or cooling the painted surfaces of the motor vehicle to produce the change. For example to use the vehicle's air conditioner and heater to force heated and cooled air into the body panels of the car to heat and cool the exterior color changing paint.

5- We claim a method of inducing a color change effect on a motor vehicle by remote control devices comprising:
a—A radio transmitter to send a unique signal to the receiver.
b—A radio receiver which activates a switch to engage and disengage an electrical heating device located adjacent to the vehicle substrate parts to cause a color change.
c—A radio receiver which activates a switch to engage and disengage the cooling device located adjacent to the vehicle substrate parts to cause a color change.
